(19) United States
(12) Patent Application Publication
(10) Pub. No.: US 2025/0043827 A1
(43) Pub. Date: Feb. 6, 2025

(54) WHEEL HUB UNIT

(71) Applicant: AKTIEBOLAGET SKF, GOTEBORG (SE)

(72) Inventors: Riccardo NARDICCHIA, Torino (IT); Maurizio BERTOLA, Piscina (IT); Giancarlo BRANCA, Rivoli (IT)

(21) Appl. No.: 18/768,422

(22) Filed: Jul. 10, 2024

(30) Foreign Application Priority Data
Aug. 1, 2023 (IT) 102023000016188

(51) Int. Cl. F16C 33/80; F16C 19/38

(52) U.S. Cl. CPC F16C 33/805; F16C 19/386; F16C 2326/02

(57) ABSTRACT

A vehicle wheel hub unit includes radially inner and outer rings made mutually rotatable by a plurality of rolling elements therebetween and an axially symmetric seal assembly. The seal assembly includes a shield mounted with an interference fit on the radially inner ring, and the shield has an annular flanged portion and a mounting portion integral with the annular flanged portion. The mounting portion is tubular and extends parallel to a bearing axis of rotation when mounted on the radially inner ring and makes a first circumferentially constant angle relative to a shield axis of rotation before being mounted on the radially inner ring, and the annular flanged portion is perpendicular to the bearing axis of rotation when mounted on the radially inner ring and makes a second circumferentially constant angle relative to the shield axis of rotation before being mounted on the radially inner ring.

### CROSS-REFERENCE

This application claims priority to Italian patent application no. 102023000016188 filed on Aug. 1, 2023, the contents of which are fully incorporated herein by reference.

### TECHNOLOGICAL FIELD

The present disclosure is directed to a wheel hub unit for vehicles.

### BACKGROUND

Known wheel hub units may comprise a flanged rotary hub mechanically connected to a rotary element of the motor vehicle, for example the wheel or the disc of a braking element, and a rolling bearing comprising an outer ring, a pair of inner rings, one of which may be the flanged hub itself, and a plurality of rolling bodies, for example balls. All of these components have axial symmetry about the rotation axis of the rotary elements, for example the flanged hub and the inner rings of the rolling bearing.

The rolling bearings also have sealing devices (“seals” or “seal assemblies”) towards the axially outer side and/or towards the axially inner side of the wheel hub unit to protect the raceways and rolling bodies from external contaminants and to provide a seal for the lubricating grease. Typically, such sealing devices are made up of an elastomer liner co-molded on a first shaped metal shield and interference mounted on one of the rings of the bearing unit, for example the stationary radially outer ring. The elastomer liner is provided with contacting sealing lips that provide the seal by means of a sliding contact with a rotary metal surface. Normally, this metal surface belongs to a second shaped metal shield that is interference mounted onto the other ring of the bearing unit, for example the flanged rotary radially inner ring. The second shaped shield may for example comprise an annular flanged portion and a tubular mounting portion that are connected together to form an L-shape.

The second shaped shield is mounted on a cylindrical seat of the flanged radially inner ring using a tool and pressing the shield axially into a final position using a standardized mounting procedure. Interference mounting guarantees a final position that is stable over time.

However, during the interference mounting operation, the shaped shield always undergoes a degree of plastic deformation. The main factors affecting this deformation are the values (amount) of the interference between the shield and the inner ring, as well as the diameter, the shape and the thickness of the shield.

Very high interference conditions create large amounts of plastic deformation. In particular, the tubular portion is deformed. About 360°, this portion ceases to be cylindrical and becomes conical, which can lead to various problems including a reduction of the contact zone. Contact between the tubular portion of the shield and the cylindrical seat of the inner ring is no longer guaranteed along the entire axial length of the tubular portion, but is substantially reduced and concentrated in the connection zone between the tubular portion and the annular flanged portion of the shield. Another problems that results is a non-uniform contact zone. Furthermore, reduced contact is not guaranteed to be uniform about 360° as a result of structural instabilities (“buckling”) of the tubular portion of the shield and inevitable errors in perpendicularity and axiality occurring during the mounting process.

Furthermore, high interference conditions also cause plastic deformation of the annular flanged portion, which, once mounted, will not be perpendicular to the axis of the rolling bearing.

The plastic deformation of the shield adversely affects the static seal between the shield itself and the inner ring which may lead to, among other things, reduced sealing performance against external contaminants, and consequently corrosion and reduced service life of the bearings, and an inability to keep the base oil of the grease inside the bearing. This effect creates problems during storage and/or operation of the bearing, and the loss of oil can reduce the performance levels of the bearing itself.

Furthermore, the plastic deformation of the shield affects the friction torque of the sealing device because the reciprocal position between the second shield and the contacting lips of the first shield move away from the design conditions. This means that the contact pressure of the lips may be adversely affected and there may be unwanted contact and/or interference between the second shield and the elastomer liner of the first shield of the sealing device.

One solution to these problems could be to reduce the interference between the shield and the inner ring, in which case the plastic deformations described above would be less pronounced on account of the low-interference conditions. However, interference cannot be reduced too much given the risk of axial slipping of the shield during operation, with vibrations, deformations of the components under load and temperature being factors that contribute to the slipping of the shield. A minimum extraction force for extracting the shield from the seat thereof is therefore required, thereby limiting the minimum usable interference values.

### SUMMARY

The present disclosure is intended to provide a wheel hub unit for vehicles that overcomes the above drawbacks and others and that is easy and inexpensive to make.

A first aspect of the disclosure comprises a wheel hub unit for vehicles that has a radially outer ring, a radially inner ring, and a plurality of rolling elements interposed between the radially inner ring and the radially outer ring to make the radially inner ring and the radially outer ring relatively rotatable with respect to a bearing axis of rotation. The unit also includes an axially symmetric seal assembly having a shaped shield mounted with an interference fit on the radially inner ring, the shaped shield having an annular flanged portion and a mounting portion integral with the annular flanged portion. The mounting portion is tubular and extends parallel to the axis of rotation when the mounting portion is mounted on the radially inner ring and is conical and makes a first circumferentially constant angle a relative to a shield axis of rotation before the mounting portion is mounted on the radially inner ring. Also, the annular flanged portion is perpendicular to the bearing axis of rotation when the mounting portion is mounted on the radially inner ring and makes a second circumferentially constant angle b relative to the shield axis of rotation before the mounting portion is mounted on the radially inner ring.

### BRIEF DESCRIPTION OF THE DRAWINGS

The invention is described below with reference to the attached drawings, which show a non-limiting example embodiment thereof.

FIG. 1 is a schematic radial cross sectional view of a preferred embodiment of a wheel hub.

FIG. 2 is a magnified view of a detail of the wheel hub unit of FIG. 1.

FIG. 3 is a schematic view of a shield of the wheel hub unit of FIG. 1 in a first configuration.

FIG. 4 is a schematic view of the shield of FIG. 3 in a second configuration.

### DETAILED DESCRIPTION

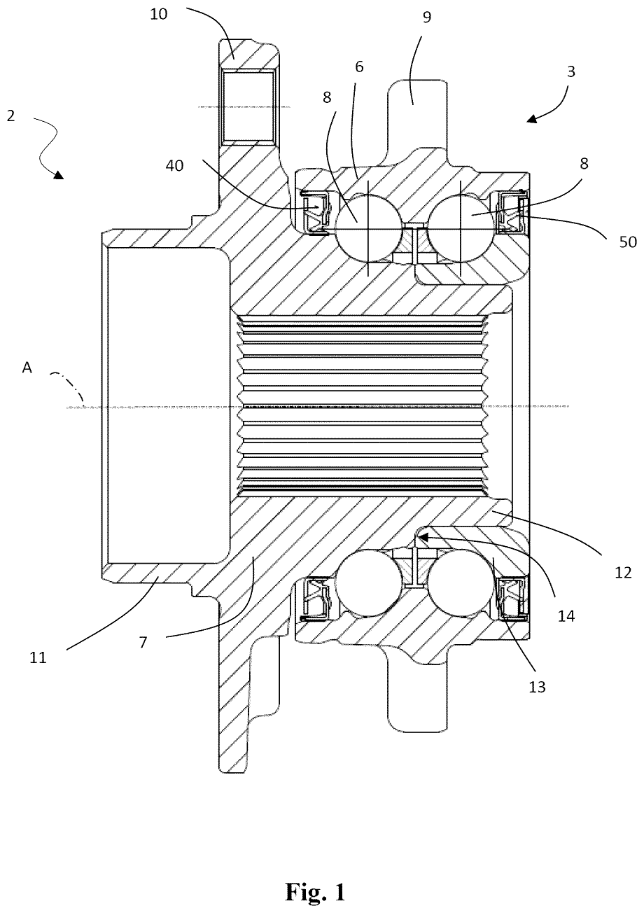

With reference to FIG. 1, a wheel hub assembly 2 according to the present disclosure includes a rolling bearing 3, which has two rows of rolling bodies (balls) in the example illustrated.

The wheel hub 2 is configured to bear a wheel (not illustrated) of a vehicle rotatably about a rotation axis A.

The wheel hub unit 2 includes a radially outer ring 6, a radially inner ring 7, and a plurality of rolling bodies 8, comprising two rows of balls arranged side by side in the example shown, interposed between the inner ring 7 and the outer ring 6 to enable the relative rotation thereof.

Throughout the present description and in the claims, terms and expressions indicating positions and orientations, such as “radial” and “axial”, are to be understood with reference to the central rotation axis A of the rolling bearing 3. On the other hand, expressions such as “axially outer” and “axially inner” refer to the mounted state of the wheel hub unit, and in this case preferably refer to a wheel side and to a side opposite the wheel side, respectively.

The rings 6 and 7 and the rolling bodies 8 are part of the rolling bearing 3. In the non-limiting example illustrated, the rolling bearing 3 is a “third generation” bearing, and therefore directly forms the entire wheel hub unit 2, since the radially outer ring 6 comprises a known flange 9 that is used for attachment to the suspension pillar (not illustrated, for simplicity) and is integral with the outer ring 6, and since the radially inner ring 7 comprises a known flange 10 that is used to attach the wheel of the vehicle (not illustrated, for simplicity) and is integral with the radially inner ring 7, particularly at an axial end thereof 11 opposite the flange 9 and a second end 12 of the radially inner ring 7.

In the non-limiting, preferred example illustrated, the radially inner ring 7 is also split, according to a known configuration, into two separate elements that are angularly and rigidly coupled together, one element being an annular element formed by the axial ends 11, 12 and the one-piece flange 10, and the other element being a known small inner ring 13, which is driven onto the end 12 to butt axially against an axial shoulder 14 of the radially inner ring 7 oriented towards the end 12.

The rolling bearing further comprises an axially outer sealing device 40 (seal assembly), and an axially inner sealing device 50 (seal assembly).

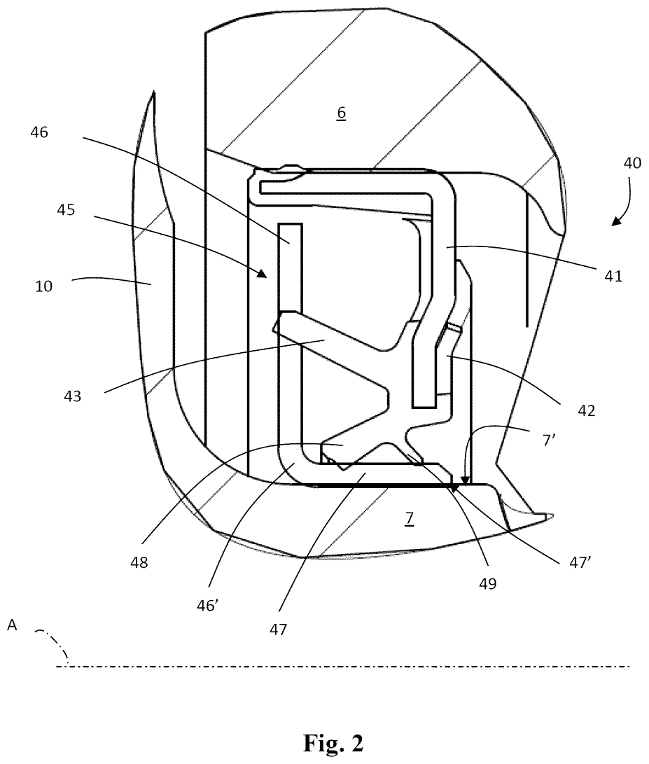

With reference to FIG. 2, the sealing device 40 is symmetrical about the rotation axis A of the rolling bearing and may include a first shaped metal shield 41 interference mounted onto the radially outer ring 6, a second shaped metal shield 45 that is L-shaped. The second shaped shield 45 is interference mounted onto the radially inner ring 7 and has an annular flanged portion 46 perpendicular to the rotation axis A of the rolling bearing and with a tubular mounting portion 47 parallel to the rotation axis A and rigidly connected to the annular flanged portion 46. The radially inner end of the annular flanged portion 46 has a connection elbow 46′ with the tubular portion 47. In turn, the tubular mounting portion 47 has, at the axially inner end thereof opposite the elbow 46′, an end edge 47′ that is tapered at the radially outer portion thereof.

The second shaped shield 45 further includes an elastomer liner 42 co-molded on the first metal shield 41 and provided with an axial lip 43 and with a first radial lip 48 and a second radial lip 49 for retaining grease arranged axially inside the first radial lip 48. All of the lips are contacting lips and create a sliding contact: the axial lip 43 against the annular flanged portion 46 of the second shaped shield 45, and the radial lips 48, 49 against the tubular portion 47 of the second shaped shield 45.

The second shaped shield 45 is mounted on a mounting seat 7′ of the radially inner ring 7 using a tool that presses the shield axially into the final position thereof, using a standardized mounting procedure. Interference mounting guarantees a final position of the shaped shield 45 that is stable over time.

According to embodiments of the present invention, the wheel hub unit 2 is characterized in that the axially outer sealing device 40, and more specifically the second shaped shield 45, have characteristics selected to substantially eliminate the problem of plastic deformation of the second shaped shield 45.

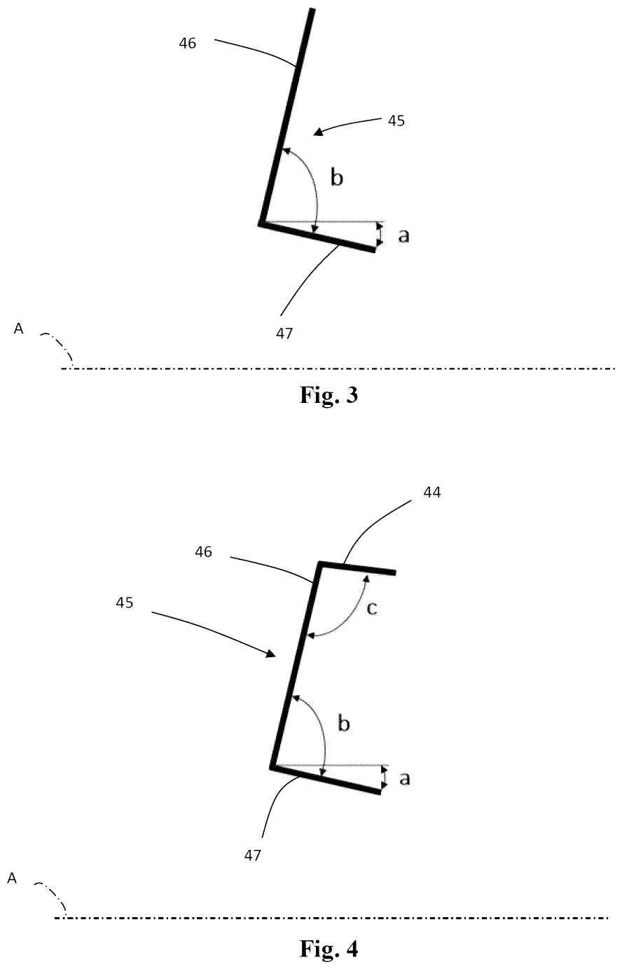

With reference to FIG. 3, the second shaped shield 45 is characterized by a geometry for minimizing the effects of plastic deformations when the shield 45 is mounted on the radially inner ring 7. The effects of the unwanted deformations of the tubular mounting portion 47 and of the annular flanged portion 46 are minimized over the entire interference variation range.

In particular, according to the present disclosure, the tubular mounting portion 47 is keyed onto the mounting seat 7′ of the radially inner ring and has a first circumferentially constant inclination a with respect to the rotation axis A of the rolling bearing 3 (maintaining axial symmetry with respect to the rotation axis A). This first inclination means that the end edge 47′ is arranged radially inside the elbow 46′. In addition, the annular flanged portion 46 has, with respect to the tubular portion 47, a respective second inclination b that is also circumferentially constant.

Since the tubular mounting portion 47 and the annular flanged portion 46 are rigidly connected to one another, when the tubular mounting portion 47 is keyed onto the mounting seat 7′, the tubular portion 47 is deformed to fully conform to the mounting seat 7′ (the tubular portion 47 therefore being parallel to the rotation axis A of the rolling bearing 3) by rotating about a center of rotation defined by the elbow 46′, while the annular flanged portion 46 rotates by the same angle with respect to the elbow 46′ and is positioned in a plane perpendicular to the rotation axis A.

Finite element simulations and experimental tests have demonstrated that plastic deformation of the shield during assembly is best prevented with values of the first inclination a of between 0.5° and 3°.

A range of values for the second inclination b may be defined as a function of the value of the first inclination a. The same calculations and experimental evidence require the following relationship to be satisfied:

$$( 90 ° - 0.6 a ) < b < ( 90 ° + 0.6 a )$$

For example, if the first inclination a is the maximum value, i.e. 3°, the second inclination b is then between 88.2° and 91.8°.

With reference to FIG. 4, the second shaped shield 45 could, in a different configuration, be C-shaped, i.e. be provided with a second tubular portion 44 arranged radially outside the tubular mounting portion 47.

The geometric optimizations intended to reduce the effects of the plastic deformations remain unchanged and therefore the following also applies to the configuration illustrated in FIG. 4: the first inclination a between the tubular mounting portion 47 and the rotation axis A of the rolling bearing 3 has a value of between 0.5°, and 3° and the second inclination b between the tubular mounting portion 47 and the annular flanged portion 46 assumes the values defined by the aforementioned relationship:

$$( 90 ° - 0.6 a ) < b < ( 90 ° + 0.6 a )$$

Furthermore, in the case of the C-shaped second shaped shield 45, a third inclination c may be defined between the annular flanged portion 46 and the second tubular portion 44, which is also circumferentially constant. This third inclination is intended to ensure that the second tubular portion 44 is returned to a position parallel with the rotation axis A of the rolling bearing 3 once mounting is completed. The improved results are obtained with a value of the third incline c equal to or greater than 90°. In particular, the following relationship can be defined:

$$c = 90 ° + k$$

where the parameter k is between 0% and 50% of the first inclination a.

Advantageously, the second shaped shield 45 (in both of the described configurations) is made of sheet metal, for example AISI430 steel. The thickness of the tubular portion 47 and the thickness of the annular flanged portion 46 may be between 0.4 mm and 0.8 mm.

The jamming effect of the end edge 47′ on the mounting seat 7′ of the radially inner ring 7 is used to increase the extraction force of the shaped shield 45, thereby obtaining a greater extraction force at equal interference.

The interference values (diametric interference between the tubular mounting portion 47 and the mounting seat 7′) may be between 0.05 mm and 0.35 mm, these values being defined at the end edge 47′.

Finally, the mounting seat 7′ of the flanged radially inner ring 7 is preferably made of series G55/G70 steel with a ground finish and a roughness Ra not exceeding 0.8 μm.

In short, the solution according to the present invention has numerous advantages such as they result in friction torque values of the sealing device that are near-constant and repeatable, i.e. less affected by the different sealing pressure on the contacting lips resulting from the plastic deformation of the shaped shield 45. In addition, unwanted contact is avoided between the rotary second shaped shield 45 and the non-rotary elements (first shaped shield 41 and elastomer liner 42) of the sealing device 40, and the conical geometry facilitates the mounting procedure, providing a self-aligning effect. Furthermore, axial eccentricity errors of the annular flanged portion 46 of the shaped shield 45 are minimized,

In addition, since the static seal is distributed over the entire surface of the tubular mounting portion 47, the axial length thereof can be minimized. This enables the sealing devices to be more axially compact, and consequently the rolling bearing can have more space for the rolling bodies 8 (if the objective is greater rigidity) or be more compact as a whole. Furthermore, the interference between the mounting seat of the radially inner ring and the tubular portion of the shaped shield can be kept large enough to guarantee a high extraction force and to prevent the shield from slipping during operation and the undeformed tubular portion and the end edge thereof contribute to keeping the extraction force high, with no risk of the shield slipping during operation.

In addition to the embodiments described above, numerous other variants of the invention are possible. It should also be understood that said embodiments are merely examples and do not limit the scope of the invention, the applications thereof, or the possible configurations thereof. Indeed, although the description provided above enables the person skilled in the art to carry out the present invention at least according to one example configuration thereof, numerous variations of the components described could be used without thereby departing from the scope of the invention, as defined in the attached claims interpreted literally and/or according to their legal equivalents.

What is claimed is:

1. A wheel hub unit for vehicles comprising:
a radially outer ring,
a radially inner ring,
a plurality of rolling elements interposed between the radially inner ring and the radially outer ring to make the radially inner ring and the radially outer ring relatively rotatable with respect to a bearing axis of rotation, and
an axially symmetric seal assembly including a shaped shield mounted with an interference fit on the radially inner ring, the shaped shield having an annular flanged portion and a mounting portion integral with the annular flanged portion,
wherein the mounting portion is tubular and extends parallel to the bearing axis of rotation when the mounting portion is mounted on the radially inner ring and the mounting portion is conical and makes a first circumferentially constant angle a relative to a shield axis of rotation before the mounting portion is mounted on the radially inner ring, and
wherein the annular flanged portion is perpendicular to the bearing axis of rotation when the mounting portion is mounted on the radially inner ring and the annular flanged portion makes a second circumferentially constant angle b relative to the shield axis of rotation before the mounting portion is mounted on the radially inner ring.

2. The wheel hub unit according to claim 1,
wherein the first angle is from 0.5° to 3°.

3. The wheel hub unit according to claim 2,
wherein the second angle is defined by the relation: (90°−0.6a)<b<(90°+0.6a).

4. The wheel hub unit according to claim 3,
wherein the shaped shield has a second portion radially external to the mounting portion, the second portion making a third circumferentially constant angle c with respect to the annular flanged portion.

5. The wheel hub unit according to claim 4,
wherein the third angle c is defined by the relation:
$$c = 90 ° + k$$
wherein k is a parameter equal to 0% to 50% of the first angle a.

6. The wheel hub unit according to claim 1
wherein the mounting portion has an axially internal end edge.

7. The wheel hub unit according to claim 6,
wherein the shaped shield is made of sheet metal, and
wherein a thickness of the mounting portion and the annular flanged portion is between 0.4 mm and 0.8 mm.

8. The wheel hub unit according to claim 6,
wherein a diametral interference between the mounting portion and a mounting seat at the end edge is from 0.05 mm to 0.35 mm.

9. The wheel hub unit according to claim 8,
wherein the mounting seat is made of steel and has a roughness Ra less than or equal to 0.8 μm.

10. The wheel hub unit according to claim 1,
wherein the mounting portion is mounted on a cylindrical surface of the radially inner ring.

11. A method comprising:
providing a radially outer ring, a radially inner ring and a plurality of rolling elements interposed between the radially inner ring and the radially outer ring to make the radially inner ring and the radially outer ring relatively rotatable with respect to a bearing axis of rotation,
providing an axially symmetric seal assembly including a shaped shield having an annular flanged portion and a mounting portion integral with the annular flanged portion, the mounting portion being conical and making a first circumferentially constant angle a relative to a shield axis of rotation and the annular flanged portion making a second circumferentially constant angle b relative to the shield axis of rotation,
pressing the shaped shield onto a cylindrical portion of the radially inner ring with an interference fit such that the mounting portion is caused to become cylindrical by engagement with the radially inner ring and the annular flanged portion is caused to become perpendicular to the bearing axis of rotation.

12. The wheel hub unit according to claim 11,
wherein angle a is from 0.5° to 3°.

13. The wheel hub unit according to claim 12,
wherein angle b is defined by the relation: (90°−0.6a)<b<(90°+0.6a).
